(19) United States
(12) Patent Application Publication
(10) Pub. No.: US 2025/0190720 A1
(43) Pub. Date: Jun. 12, 2025

(54) METHOD FOR AUTOMATED COMMUNICATION CONTENT GENERATION AND TRANSLATION

(71) Applicant: Present Communications, Inc., Redwood City, CA (US)

(72) Inventor: Matt Mireles, Redwood City, CA (US)

(21) Appl. No.: 18/974,640

(22) Filed: Dec. 9, 2024

Related U.S. Application Data
(60) Provisional application No. 63/703,583, filed on Oct. 4, 2024.
(60) Provisional application No. 63/631,351, filed on Apr. 8, 2024.
(60) Provisional application No. 63/574,676, filed on Apr. 4, 2024.
(60) Provisional application No. 63/607,519, filed on Dec. 7, 2023.

(51) Int. Cl. G06F 40/58; H04L 51/21

(52) U.S. Cl. CPC G06F 40/58; H04L 51/21

(57) ABSTRACT

One variation of a method includes: accessing an inbound message in a first format, sent to a user, and accessed by the user via an application executing on a computer system; identifying a sender class associated with the inbound message; accessing user preferences defining target language signals and target sender characteristics to present to the user based on the sender class; extracting the target language signals from the inbound message; retrieving the target sender characteristics from an external database; identifying a target output format, different from the first format, for the target language signals and the target sender characteristics based on the sender class and a sender specification assigning target output formats to inbound messages based on sender class; transforming the target language signals and the target sender characteristics into an output in the target output format; and serving the output to the user.

### CROSS-REFERENCE TO RELATED APPLICATIONS

This application claims the benefit of U.S. Provisional Application No. 63/703,583, filed on 4 Oct. 2024, U.S. Provisional Application No. 63/631,351, filed on 8 Apr. 2024, U.S. Provisional Application No. 63/574,676, filed on 4 Apr. 2024, and U.S. Provisional Application No. 63/607,519, filed on 7 Dec. 2023, each of which is incorporated in its entirety by this reference.

### TECHNICAL FIELD

This invention relates generally to the field of communication and more specifically to a new and useful method for generating and translating communication content in the field of communication.

### BRIEF DESCRIPTION OF THE FIGURES

FIG. 1 is a flowchart representation of a first method;

FIG. 2A is a flowchart representation of one variation of the first method;

FIG. 2B is a flowchart representation of one variation of the first method;

FIG. 2C is a flowchart representation of one variation of the first method;

FIG. 2D is a flowchart representation of a second method;

FIG. 2E is a flowchart representation of one variation of the second method; and

FIG. 3 is a flowchart representation of one variation of the second method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. FIRST METHOD: CONTEXTUAL SELF-TO-SELF COMMUNICATION TRANSFORMATION

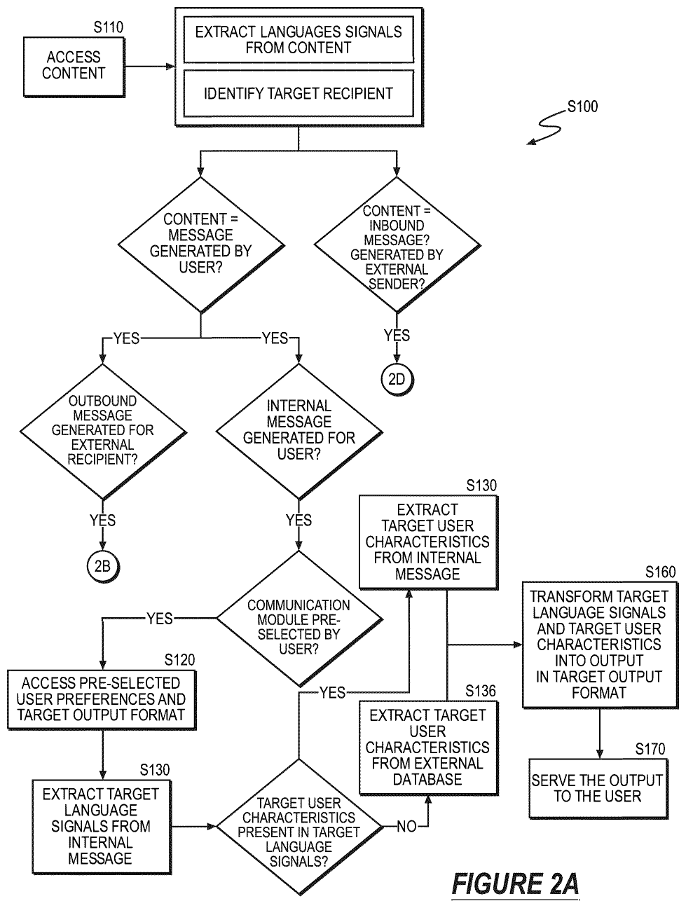

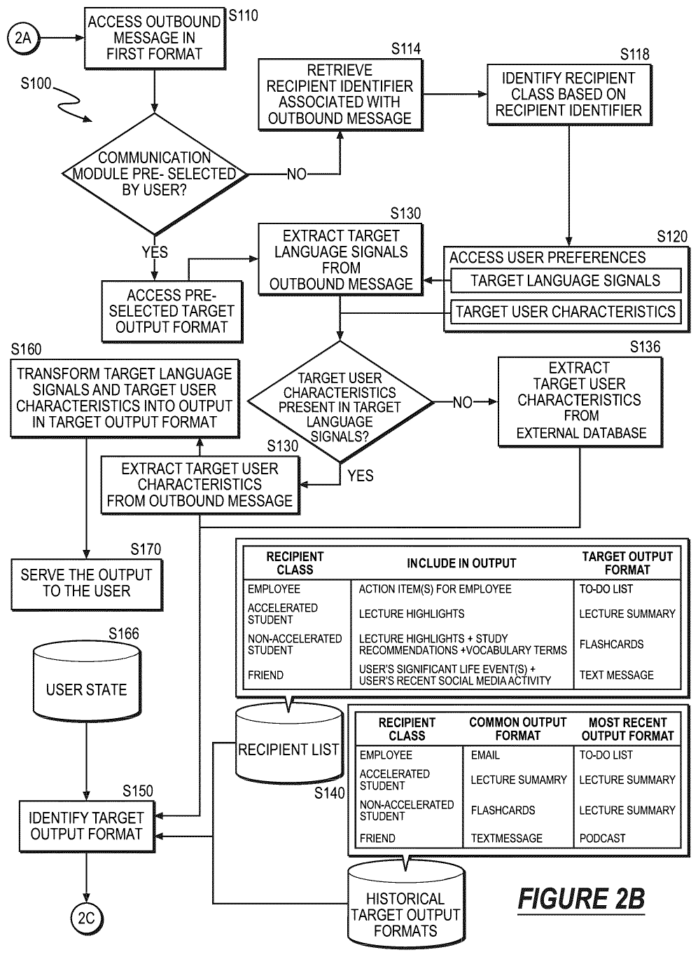

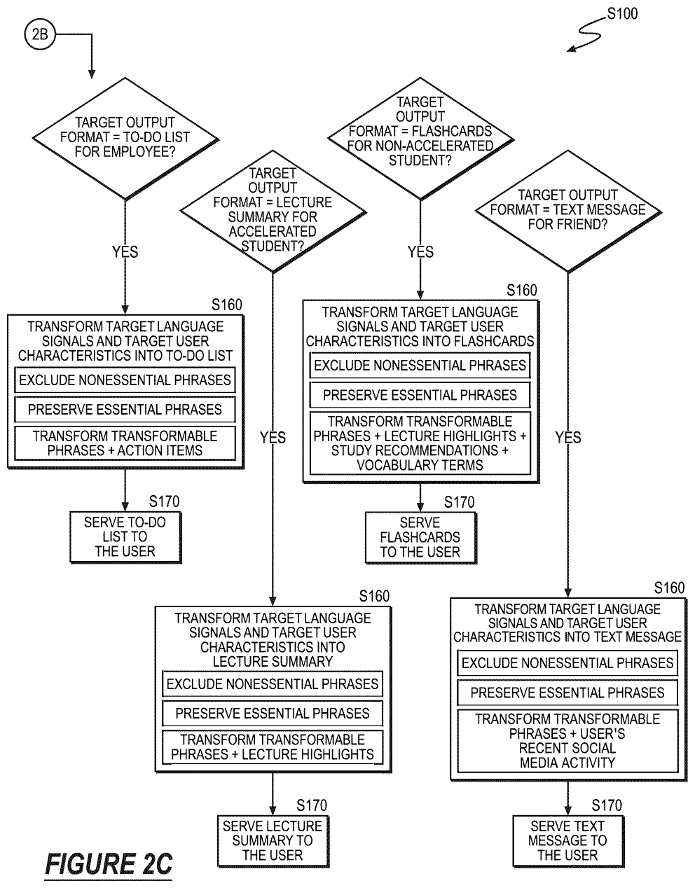

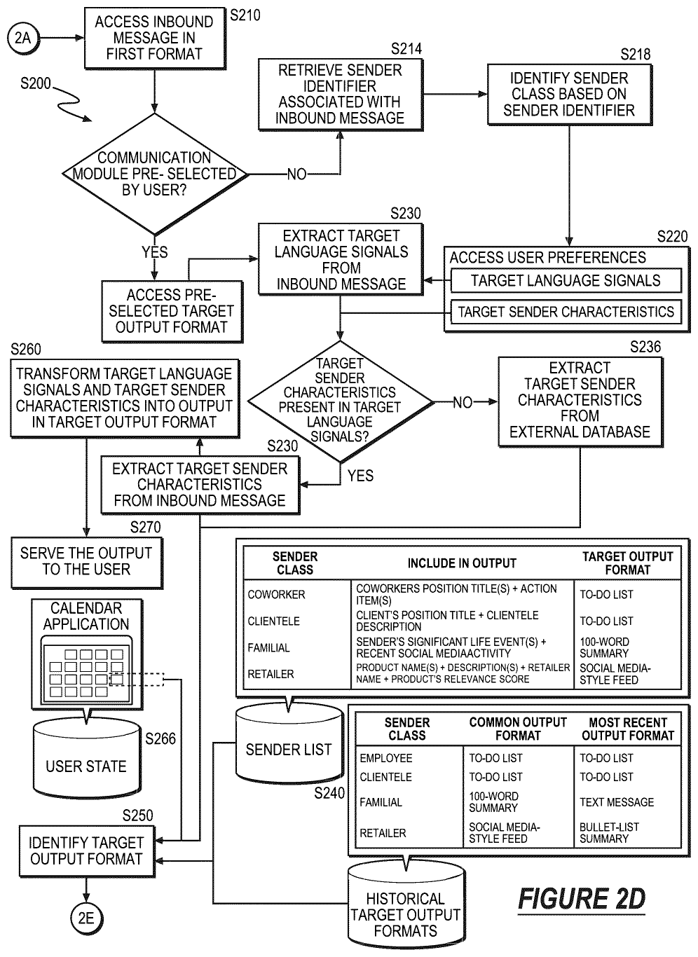

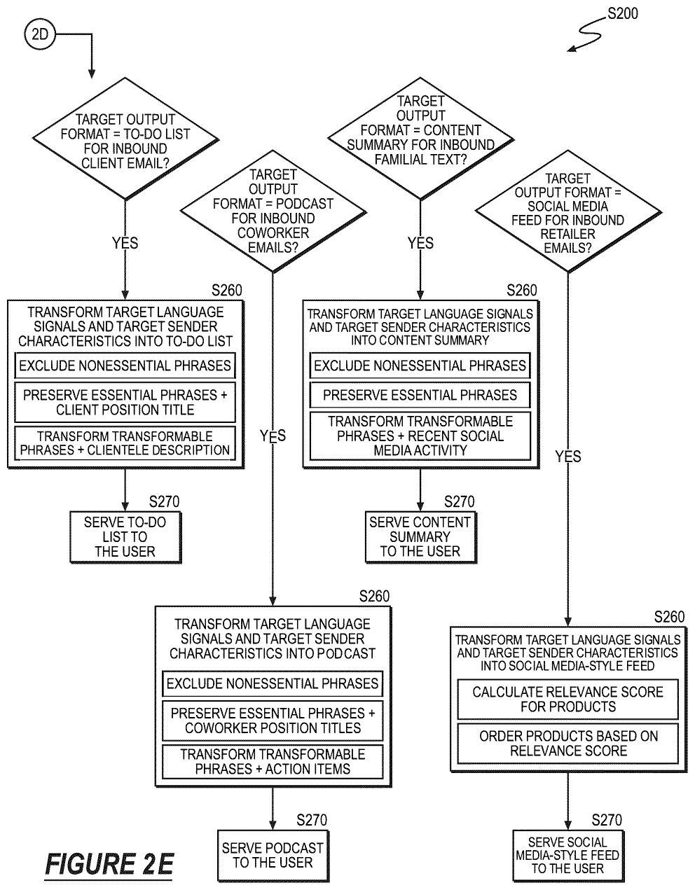

As shown in FIG. 2A, a first method S100 includes accessing an outbound message in a first format, captured by a user via a voice recorder integrated in an application executing on a computer system in Block S110. This variation of the first method S100 also includes receiving selection of a communication module from a user, the communication module defining: a set of target language signals and a set of target user characteristics to present to the user; and a target output format, different from the first format, for the set of target language signals and the set of target user characteristics in Block S120.

This variation of the first method S100 also includes: extracting the set of target language signals from the outbound message in Block S130; retrieving the set of target user characteristics from an external database based on the set of user preferences in Block S140; transforming the set of target language signals and the set of target user characteristics into an output in the target output format in Block S160; and serving the output to the user in Block S170.

### 1.1 Variation: Contextual Outbound Communication Transformation

As shown in FIGS. 2A, 2B, and 2C, one variation of the first method S100 includes: accessing an outbound message in a first format, captured by a user via a voice recorder integrated in an application executing on a computer system in Block Silo; transcribing the audio message into a set of language signals in Block S115; and selecting a set of input prompts from a set of predefined input prompts, each input prompt in the set of predefined input prompts defining a target output format, and a definition of abstraction of target language signals in Block S120.

This variation of the first method S100 also includes, for each input prompt in the set of predefined input prompts: identifying a set of target language signals, in the set of language signals, based on the definition of abstraction of target language signals defined in the input prompt in Block S130; inserting the set of target language signals into the input prompt to generate a transform prompt in Block S164; serving the transform prompt to a language model; and presenting an output of the language model, responsive to the transform prompt, to the user in Block S170.

### 1.2 Variation: User-Defined Communication Modules

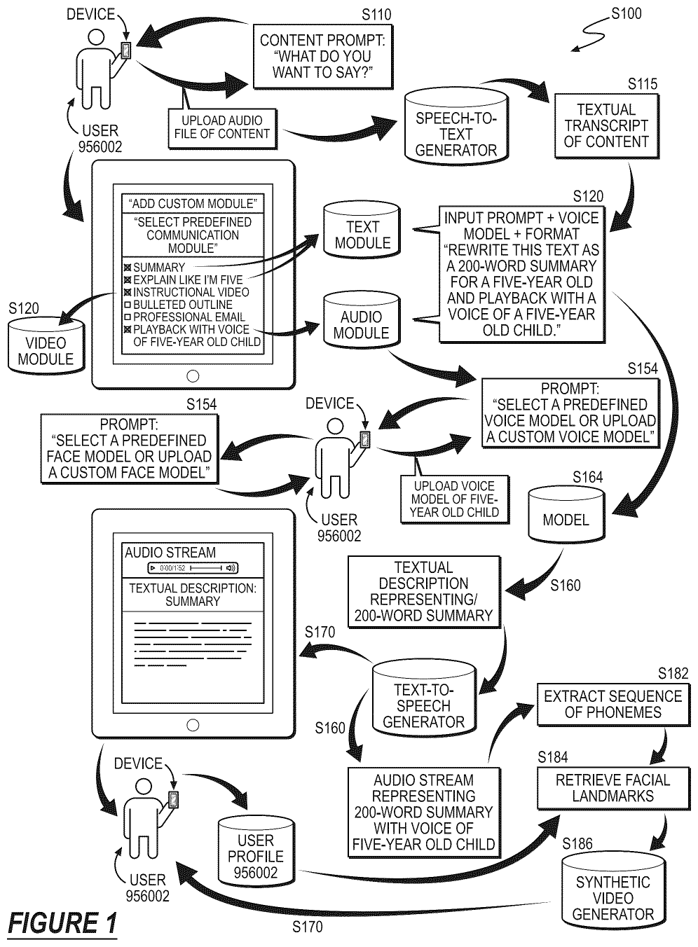

As shown in FIG. 1, one variation of the first method S100 includes, during an initial time period at a computer system: accessing an audio recording of content captured by a voice recorder integrated in an application executing on a computer system in Block Silo; transforming the audio recording into a textual transcript in Block S115; accessing a text module and an audio module from a communication module specification, each communication module, in the communication module specification, defining an input prompt and a target output format in Block S120; and prompting the user to upload a voice model for the audio module in Block S154.

This variation of the first method S100 further includes, during the initial time period: inserting the textual transcript, the text module, and the audio module, into a language model (e.g., a large language model, a generative pre-trained transformer model) to generate a first textual description according to a first input prompt and a first target output format defined in the text module and the audio module in Block S164; transforming the first textual description into a first audio stream based on the voice model in Block S160; and serving the first textual description and the first audio stream to the user in Block S170.

This variation of the first method also includes, during a first time period at the computer system: receiving selection of a video module defining a second input prompt and a second target output format in Block S120; in response to receiving selection of the video module, prompting the user to upload a face model and a second voice model for the video module in Block S154; inserting the textual transcript and the video module into the language model to generate a second textual description according to the second input prompt and the second target output format in Block S164; and transforming the textual description into a second audio stream based on the second voice model in Block S160.

This variation of the first method S100 further includes, during the first time period: extracting a sequence of phonemes from the second audio stream in Block 182; retrieving a pre-generated sequence of speech-type facial landmark containers representing motion of the user's face with mouth movements that correspond to generic speech from a user profile associated with the user in Block 184; inserting the sequence of phonemes, the pre-generated sequence of speech-type facial landmark containers, and the face model into a synthetic video generator to generate a video stream of synthetic face images representing the user's predefined expressions and physiognomy in Block S186; and serving the second textual description, the second audio stream, and the video stream of synthetic face images to the user within the application in Block S170.

### 2. APPLICATIONS

Generally, Blocks of the first method S100 can be executed by a computer system (e.g., a remote computer system, a computer network, a remote server) in conjunction with an application (e.g., a native or web application) (hereinafter “the system”): to receive content—such as an audio recording, a writing sample, or a textual description—via an instance of the application executing on a computing device (e.g., a smartphone, a tablet, a laptop computer, a desktop computer) accessed by the user; to implement speech recognition techniques to transcribe the audio recording into a textual transcript; to receive selection of a set of communication modules, each communication module defining an input prompt specifying a target output format—such as a content format (e.g., bulleted text, block text, a typeface, text spacing), a voice model, a face model, a language, and/or a dialect—within a communication domain (e.g., a written domain, an audio domain, a video domain); and to feed these communication module and textual transcript pairs—in parallel—into a language model (e.g., a large language model, a generative pre-trained transformer) to transform the textual transcript into a set of textual descriptions based on input prompts contained in each selected communication module.

The system can then present these textual descriptions to the user, thereby enabling the user to consume contents of the original audio recording in a range of text versions characterized by: different levels of abstraction (e.g., a content summary, complete content, or expanded content); language complexity (e.g., keywords, text snippets, or fully-punctuated prose); reading level (child versus adult reading levels); and/or text format (e.g., bulleted concepts, block text, or text content organized by chapter or section heading).

Additionally, the system can: receive selection of an audio module or a combination communication module (e.g., a linked text module and an audio module) defining an input prompt specifying a particular format and a voice model within the audio communication domain; feed the audio module or the combination communication module into the language model to transform the textual transcript into a textual description according to the input prompt; insert this textual description into a speech-to-text generator to generate an audio file or an audio stream of the textual description with the voice model; and present the audio stream to the user within the application. Thus, by transforming the textual transcript into an audio stream, the system enables the user to multi-task while listening to the quick audio stream of content rather than manually reviewing a textual description of the content for a longer duration.

Additionally or alternatively, the system can receive selection of a video module or a combination communication module (e.g., a linked text module and a video module) defining an input prompt specifying a particular format, a voice model, and a face model within the video communication domain and feed the video module or the combination communication module into the language model to transform the textual transcript into a textual description according to the input prompt. The system can insert this textual description into the speech-to-text generator to generate an audio stream of the textual description with the voice model; extract a sequence of speech characteristics (e.g., phonemes) from the audio stream; and retrieve a face model and a pre-generated sequence of speech-type facial landmark containers representing motion of a face with mouth movements that correspond to generic speech corresponding to the input prompt. The system can further feed the sequence of phonemes, the pre-generated sequence of speech-type facial landmark containers, and the face model into a synthetic video generator to generate a video file or video stream of synthetic face images representing the face model with predefined expressions and physiognomy; and serve the video stream of synthetic face images to the user within the application.

Thus, by transforming the textual transcript into a video stream, the system enables the user to watch and listen to a video stream of content corresponding to the user's visual communication preference rather than manually reviewing a textual description of the content.

Therefore, Blocks of the first method S100 can be executed by the system: to automatically transform content (e.g., an audio recording, a written description) and a set of input prompts—defined in a set of communication modules selected by the user—into a new textual description, audio stream, and/or video stream according to the set of input prompts; and to serve the new textual description, audio stream, and/or video stream to the user within the application. Additionally, the system can enable the user to translate, transcribe, and transform ideas and thoughts into a particular form of content that corresponds to the user's communication preference or preferred learning style—such as a video stream for visual learning, an audio stream for auditory learning, and/or a textual description for reading and writing learning.

### 2.1 Universal Internal+Outbound Translator

The system can transform a textual transcript and communication module pair into a textual description characterized by various text formats and enable the user to organize an audio recording of speech, representing the user's thoughts, into a textual description. For example, the user may provide her own audio recording, and the system can transform the audio recording into a textual transcript. The system can further: access a set of predefined (e.g., default) communication modules; insert each textual transcript and predefined communication module pair into the language model to generate a set of textual descriptions characterized by a set of text formats. Thus, the system can transform the user's thoughts and ideas into textual descriptions characterized by various text formats and thereby, enable the user to organize her thoughts, represented in the audio recording, to write a book, prepare a speech, and/or prepare a presentation.

Additionally, the system can transform a textual transcript and communication module pair into a textual description characterized by various text formats and thereby, enable the user to transform her ideas into an outbound textual description (e.g., a social media post, a text message, an email, an agenda for a meeting).

### 2.2 User Characteristics

Further, the system can: retrieve characteristics about the user; and transform these characteristics into the output to present context about the user that is relevant to the output. In one example, the user may provide her own audio recording, including a personal story (i.e., an outbound message) for a friend, and the system can retrieve contextual details about the user from an external database (e.g., a social media platform) that add context to the output for the friend, such as the user's recent social media activity (e.g., recently-shared posts relate to this personal story). In another example, the user may provide her own audio recording including a list of personal goals for the upcoming month (i.e., an internal message) for her own reflection and planning, and the system can retrieve contextual details about the user from an external database (e.g., a fitness tracking app or wearable device) that add context to the output for the user, such as recent accomplishments, upcoming events, or related reminders that align with these goals.

Additionally, the system can verify that these retrieved user characteristics correspond to the user (i.e., confirming the correct individual is identified). For example, the system can: implement a verification model (e.g., a large language model)). For example, the system can: implement a verification model (e.g., a large language model) to extract identifying details or context clues about the user from the audio recording, such as specific keywords, phrases, or references (e.g., location names, recent activities, or unique interests mentioned in the message); generate contextualized web queries based on these identifying details or context clues to locate online information related to the user; filter information associated with users that does not correspond to multiple identifying details or context clues (e.g., name, location, occupation, or specific interests) derived from the message; and cross-reference details from multiple sources or use image and text analysis to confirm the identity and relevance of the retrieved user characteristics. Therefore, the system can integrate relevant information from the outbound message and/or contextual details about the user to enhance the clarity and/or relevance of the output for the user.

### 3. TERMS

A “set of language signals” is referred to herein as the words, phrases, and contextual elements within an original communication, such as: lexical phrases including segments of text or speech (e.g., a sentence in an email, a discrete phrase extracted from an audio recording); contextual signals embedded in the original communication (e.g., a tone of the sender, a purpose of the original communication, subject matter, or urgency); and/or emphasis indicators including indicators of verbal emphasis (e.g., modulation in spoken pitch or volume) and/or textual emphasis (e.g., highlighted, emboldened, or underlined text). The set of phrases can include: nonessential phrases, such as redundant phrases, extraneous phrases, conversational fillers, and/or formalities (e.g., a salutation in an email); essential phrases, such as key details (e.g., dates, times, deadlines, event locations), specific names (e.g., people, departments, companies, projects), and/or technical terms (e.g., industry specific acronyms); and transformable phrases, such as descriptive phrases (e.g., examples, observations), interrogative phrases (e.g., requests for action), imperative phrases (e.g., instructions, commands, or action items).

A “set of target language signals” is referred to herein as a subset of the set of language signals including the words, phrases, and contextual elements (e.g., key phrases and summaries of relevant details) within a communication that are necessary to generate an output that preserves the intent or purpose of the original communication. For example, the set of target language signals can include: lexical phrases including segments of text or speech necessary to communicate core information (e.g., specific instructions or descriptions from the original message); contextual signals embedded in the communication that shape the interpretation of the message or inform the nature of the desired response (e.g., an urgent tone indicating time sensitivity); and/or emphasis indicators including indicators that prioritize certain points or convey significance (e.g., a highlighted and emboldened sentence in an email). In one example, a set of target language signals can be defined within the language model for a particular target output format. Alternatively, a set of target language signals can be defined within the language model for a particular sender class.

A “set of target sender characteristics” is referred to herein as contextual information associated with a sender of an inbound message, such as recent social media activity data (e.g., recent posts or engagements indicating interests or opinions of the sender), a professional background (e.g., a position summary representing a current role of the sender), or historical interaction data (e.g., representing previous engagements between the user and the sender). The target sender characteristics can be: extracted from the inbound message (e.g., a position title of the sender extracted from a signature in the email); and/or retrieved from an external database (e.g., a clientele description extracted from an online networking platform). Furthermore, the target sender characteristics can be transformed into the output to present contextual information about the sender to the user. In one example, a set of target sender characteristics can be defined within the language model for a particular sender class.

A “target output format” is referred to herein as the mode and style by which content is transformed or rendered for the intended recipient (e.g., a recipient for an outbound message). The system can access a particular target output format for transforming messages based on the class of the sender (or the recipient). The target output format specifies communication mode preferences, such as: written communication (e.g., a bulleted-list summary, or text content organized by section heading); audio communication (e.g., a podcast); and/or video communication (e.g., a visual, instructional guide). Additionally, the target output format specifies communication style preferences, such as: an order of content (e.g., actionable item descriptions ordered at the end); a tone (e.g., a professional, casual, or comedic tone); a level of abstraction (e.g., a content summary, complete content, or expanded content); language complexity (e.g., keywords, text snippets, or fully-punctuated prose); a comprehension level (e.g., child versus adult reading levels); and/or a content limit (e.g., a word count limit, a reading duration, or a listening duration). Furthermore, for written communication, the target output format specifies a text format (e.g., bulleted concepts, block text, or text content organized by chapter or section heading). Alternatively, for audio or video communications, the target output format specifies an audio format (e.g., voice modulation, background sound inclusion), or a visual style (e.g., animation, live-action segments). In one example, a target output format can be defined within the language model for a particular sender or recipient class.

A “sender identifier” is referred to herein as an identifier (e.g., an email address, contact name, phone number) associated with a sender that identifies the sender (i.e., the originator) of an inbound message.

A “recipient identifier” is referred to herein as an identifier associated with a recipient that identifies the recipient of an outbound message.

A “class” is referred to herein as a category assigned to a sender (or a recipient) based on the sender (or recipient) identifier. For example, the class of a sender can be assigned based on a relationship type of the sender and the user (i.e., the recipient). The class of the sender (or recipient) can define the target output format, target language signals, and/or target sender characteristics necessary and/or preferred when communicating with the sender (or recipient). In one example, a recipient can be assigned a “clientele” class based on the relationship between the user generating an outbound message (i.e., a service provider) and the recipient intended to receive the outbound message (i.e., a client). In this example, based on the clientele class of the recipient, the system identifies: the target output format as an email specifying fully-punctuated prose and a professional tone; and the set of target language signals including a description of key information to convey to the client, such as project timelines, deliverables, and budget estimates related to an upcoming project.

A “communication module” is referred to herein as an audio, text, or video module that specifies an input prompt and a target output format. Each communication module defines a set of target language signals and a set of target user and/or sender characteristics for including in the output. In addition to receiving or accessing content, the system can receive selection of a communication module from the user. Alternatively, in absence of a selection from the user, the system can interpret the content and the state of the user, and identify a target output format (e.g., based on a sender class).

### 4. INITIAL SETUP: CONTENT CAPTURE

Generally, the system can host or interface with an application (e.g., a web or native application) executing on a computing device (e.g., a smartphone, a tablet, a laptop computer, a desktop computer) accessed by the user and a language model (e.g., a large language model, a generative pre-trained transformer) to transform content into a new textual description of varying communication formats for the user.

In one implementation, during an initial setup period, the application can prompt the user to: generate a new user profile and manually populate the user profile with various information, such as a name, an age, a geographic location, contact information (e.g., a phone number, an email address), etc.; and upload this new user profile—containing the provided user information—to the system for storing in an account or profile associated with this user or in a data repository. The user may then initiate an audio content period within the application to record a segment of speech spoken by the user or an external audio source (e.g., a television, a smartphone, a tablet) via a voice recorder running on the application in “real-time”. Upon termination of the audio content period, the application can feed this audio recording into a speech-to-text transcriber to automatically generate a textual transcript of the audio recording.

In one variation, the user may upload a video file within the application and the application can then extract an audio sequence from the video file and feed this audio sequence into the speech-to-text transcriber to automatically generate a textual transcript of the video file.

In another variation, the user may upload a pre-recorded audio file within the application and the application can feed this audio recording into a speech-to-text transcriber to automatically generate a textual transcript of the pre-recorded audio file.

In yet another variation, the user may manually enter a written description into the application, and the application can then automatically transform the written description into a textual transcript. Alternatively, the user may upload a hyperlink to a webpage representing a written document (e.g., a book, a social media profile). The application can then: access the webpage representing the written document via the hyperlink; scan the webpage for textual content; detect a media format of the textual content; and, in response to the media format corresponding to plain text, the application can generate a textual transcript of the textual content.

### 5. USER INPUT PROMPT: COMMUNICATION MODULE SELECTION

Generally, once the system generates a textual transcript, the system can prompt the user to select a set of communication modules from a corpus of predefined communication modules and/or to manually enter and select a custom communication module, different from the corpus of predefined communication modules. The system can then receive a set of communication modules—each communication module representing a discrete input prompt—for transformation of the textual transcript by the language model (e.g., a large language model, a generative pre-trained transformer), as further described below. Alternatively, the system can access a corpus of predefined communication modules pre-configured by the user and/or the system.

### 5.1 Module Selection: Predefined Text Communication Modules

In one implementation, the system can prompt the user to select a set of communication modules from a corpus of predefined communication modules representing pre-generated (e.g., default) input prompts for the language model.

In one variation, the system: presents a menu within the application defining predefined text modules representing predefined input prompts grouped within a communication domain, such as a textual or written communication domain. The user then selects a single predefined communication module representing an input prompt from this menu within the written communication domain.

For example, the system can present a menu within the application defining predefined text modules defining input prompts corresponding to the written communication domain. The user may then: review the predefined text modules in the written communication domain; and select a predefined text module representing an input prompt, such as “write this text as lyrics of a song.”

In another variation, the user may select multiple predefined text modules defining input prompts from this menu within the corresponding written communication domain. For example, the system can: present a menu within the application defining predefined text modules defining input prompts corresponding to the written communication domain. The user may then: review the predefined text modules in the written communication domain; select a first predefined text module representing a first input prompt, such as “write this text as a 200-word outline”; select a second predefined text module, such as “write this text as a professional 300-word email”; and select a third predefined text module representing a third input prompt, such as, “rewrite this text as a movie script with no more than five protagonists and explain this to me as a sixteen-year old.”

Additionally, each predefined communication module includes a description—specifying additional details and/or constraints related to the input prompt—and a target output format for the language model. For example, the user may: review the predefined communication modules in the written communication domain; select a first predefined communication module representing an input prompt with a particular format, such as “write this text as a 200-word bulleted outline with a 12-point Georgia typeface.”

Therefore, the user may select an individual predefined communication module representing an input prompt within a single domain or a set of predefined communication modules defining input prompts from multiple communication domains.

### 5.2 Module Selection: Custom Text Communication Modules

In one variation, the system can receive a custom communication module, different from the corpus of predefined communication modules, manually entered by the user. In particular, the system can receive a custom text module representing a custom input prompt that is absent from the menu of predefined text modules within the application.

In one example, a college student reviews the predefined text modules within the written communication domain and identifies absence of a pre-generated input prompt for a technical paper. In this example, the college student manually enters an input prompt for a custom text module, such as “write this text as a 150-word abstract for a research paper” within the application. The system then: prompts the user to assign a name to this input prompt; receives a name of “research paper abstract;” and stores the custom communication module with the input prompt and name in the user profile associated with the college student.

### 5.3 Context Information: Target Output Format

Additionally, the system can receive a complex description—specifying additional details and/or constraints related to the input prompt—as context information for the language model.

In one implementation, the system can receive selection of a custom text module defining an input prompt. The user can then update the input prompt to specify a complex description as a particular target output format for the language model.

For example, the system can: receive selection of a custom text module defining an input prompt, such as “Rewrite this text as a 150-word paragraph for a research paper.” The user can then update the input prompt to specify a particular target output format for the language model, such as “Rewrite this text as a 150-word abstract for a research paper. Format this text with a 12-point Times New Roman typeface for the paragraph, one inch page margins, apply double line spacing, and justify the text. Assign a header of abstract with capitalized letters, a 12-point Times New Roman typeface, bolded font, and center the header text.”

In another implementation, the system can receive selection of a custom text module defining an input prompt. The user can then update the input prompt to specify a particular language as a translation instruction for the language model.

In the foregoing example, the user can update the input prompt to specify a particular language as a translation instruction for the language model, such as “Rewrite this text as a 150-word abstract for a research paper in German with a Berlin Dialect. Format this text with a 12-point Times New Roman typeface for the paragraph, one inch page margins, apply double line spacing, and justify the text. Assign a header of abstract with capitalized letters, a 12-point Times New Roman typeface, bolded font, and center the header text.”

Therefore, the user may enter additional context information such as a complex target output format or a translation instruction in the input prompt of a custom communication module rather than select from a list of predefined communication modules specifying short target output formats (e.g., a bulleted outline, a numbered list) and languages (e.g., Spanish, French, Mandarin, English, German).

### 6. MODEL

In one variation, Block S164 of the first method S100 recites inserting the textual transcript, the text module, and the audio module, into a language model (e.g., a large language model, a generative pre-trained transformer model) to generate a textual description according to a first input prompt and a first target output format defined in the text module and the audio module.

Generally, the language model can implement natural language processing techniques: to interpret a received input including a set of communication modules defining a set of input prompts and a textual transcript; to generate an output responsive to the received input; and to serve the output to the application executing on a user's device. The language model can be trained based on a corpus of training data correlating a population of writing samples—across a population of subject areas—with a population of communication content.

### 7. TEXT-TO-TEXT TRANSFORMATION

In one implementation, once the system receives selection of a text module, the system can: retrieve the textual transcript of the audio recording entered by the user; and feed the textual transcript and the text module—defining an input prompt—into the language model.

The language model can then: interpret the textual transcript and the input prompt specifying target output format as a received input; and, in response to interpreting the received input, automatically generate a textual description according to the input prompt defined in the text module and return a response to the user, via the application executing on the user's computing device, specifying the textual description.

In one variation, in response to receiving the textual transcript and the input prompt specifying a target output format, the language model can: transform the textual transcript into a textual description exhibiting a particular format based on the input prompt and the target output format; and serve the textual description exhibiting the particular format to the user within the application on the user's computing device.

In another implementation, once the system receives selection of a set of text modules, the system can: retrieve the textual transcript of the audio recording entered by the user; and feed the textual transcript and the set of text modules—defining a set of input prompts—into the language model. The language model can then: interpret the set of text modules as a set of inputs; and, in response to interpreting the set of text modules as the set of inputs, automatically generate a textual description according to each input prompt, in parallel, and return a response to the user, via the application executing on the user's device, specifying each textual description.

For example, the system can: receive selection of a set of (e.g., four) text modules and retrieve the textual transcript of an audio recording entered by the user describing a news article. Further, the system can: receive selection of a first text module, in the set of text modules, defining a first input prompt, such as “Explain this to me like a five-year old”; receive selection of a second text module, in the set of text modules, defining a second input prompt, such as “Rewrite this as a summary”; and feed the textual transcript of the news article, the first text module, and the second text module into the language model. The language model can: interpret the first input prompt defined in the first text module, in the set of text modules, as a first received input; and interpret the second input prompt defined in the second text module, in the set of text modules, as a second received input. Then, in response to interpreting the first received input and the second received input, the language model can: automatically generate a first textual description and a second textual description according to the first input prompt and the second input prompt; and return a response to the user, via the application executing on the user's device, specifying the first textual description and the second textual description.

The language model can repeat these methods and techniques for each other text module and, for each other input prompt to generate a set of textual descriptions corresponding to the set of input prompts, aggregate this set of textual descriptions into a single response, and serves this response, specifying the set of textual descriptions to the user.

Therefore, the language model can transform the textual transcript and each discrete input prompt, in parallel, into a response specifying a corresponding textual description. Accordingly, by transforming each input prompt in parallel, the system can minimize latency and enable the user to simultaneously review multiple textual descriptions in real-time (or approximating real-time) rather than reviewing a single textual description.

Additionally, the system can: compile each input prompt and each target output format, into a data container associated with each textual description; and store the data container in the user profile in the data repository.

### 7.1 Output: Downsampled+Upsampled Textual Description

In one variation, the language model can: interpret the textual transcript and the input prompt specifying a target output format as a received input; and, in response to interpreting the received input, automatically generate a downsampled textual description characterized by a target quantity of words defined in the input prompt.

For example, the language model can: interpret the textual transcript and a text communication module defining an input prompt, “Rewrite this text as a 250-word bulleted outline” as a received input; detect a quantity of 300 words in the textual transcript; extract a target quantity of 250 words from the input prompt; and, in response to detecting the quantity of 300 words exceeding the target quantity of 250 words, transform the textual transcript characterized by the quantity of 300 words into a downsampled textual description representing a bulleted outline characterized by the target quantity of 250 words.

Alternatively, the language model can: interpret the textual transcript and the input prompt specifying a target output format as a received input; and, in response to interpreting the received input, automatically generate an upsampled textual description characterized by a target quantity of words defined in the input prompt.

For example, the language model can: interpret the textual transcript and a text communication module defining an input prompt, “Rewrite this text as a 250-word bulleted outline” as a received input; detect a quantity of 200 words in the textual transcript; extract a target quantity of 250 words from the input prompt; and, in response to detecting the target quantity of 250 words exceeding the quantity of 200 words, transform the textual transcript characterized by the quantity of 200 words into an upsampled textual description representing a bulleted outline characterized by the target quantity of 250 words.

Thus, the language model can implement a text-to-text transformation by automatically upsampling or downsampling the textual transcript to generate a textual description characterized by a target quantity of words defined in the input prompt.

### 7.2 Example: Custom Communication Module

In one example, at a first time, the system prompts the user, such as a venture capitalist, to upload an audio recording within the application on the venture capitalist's smartphone. The venture capitalist uploads an audio file with content representing investment options for an early-stage startup client. The system automatically feeds the audio file into the speech-to-text generator to generate a textual transcript characterized by 600 words. At a second time, the system presents a menu of predefined communication modules within the application. The venture capitalist reviews the predefined communication modules within each domain and identifies absence of a term sheet from the menu. The venture capitalist then manually enters an input prompt for a custom communication module, such as “Rewrite this text as a 500-word term sheet of investment options. Include an employee pool, a capped participation liquidation preference, a one-year cliff and monthly vesting option, and a balanced board of directors of no more than five people chosen by mutual consent” within the application on the venture capitalist's smartphone. The system: prompts the user to assign a name to this custom communication module; receives a name of “Term Sheet;” and stores this custom communication module with the input prompt and name in the user profile associated with the venture capitalist. The system then: feeds the textual transcript of the audio file and this custom text module into the language model to transform the textual transcript into a natural language textual description representing a 500-word term sheet according to the input prompt defined in the custom communication module; and serves the textual description representing the 500-word term sheet to the venture capitalist within the application.

At a third time, the system prompts the user to select a communication module from the corpus of predefined communication modules and/or enter a custom communication module. The venture capitalist: accesses her user profile; selects the custom communication module labeled as “Term Sheet” within her user profile; and edits the input prompt, such as “Rewrite this text as a 750-word term sheet for investment options. Include an employee pool, a capped participation liquidation preference, a three-year cliff and monthly vesting option, and a balanced board of directors of no more than seven people chosen by mutual consent” within the application. The system automatically updates this custom communication module with the edited input prompt. The system then: feeds the textual transcript of the audio file and this custom communication module into the language model to transform the textual transcript into a textual description representing a 750-word term sheet according to the input prompt defined in the custom communication module; and serves the textual description representing the 750-word term sheet to the venture capitalist within the application.

Therefore, the system can receive selection of a custom communication format that is absent from the menu of predefined communication formats within an application executing on a user's computing device and thereby, enable the user to manually enter a custom communication module, repeatably edit the input prompt—defined in the custom communication module—to converge on a complex input prompt that corresponds to the user's communication preferences, and transform the user's speech into a textual description according to the complex input prompt.

### 8. AUDIO: TEXT-TO-SPEECH TRANSFORMATION

In one variation, Blocks of the first method S100 recite: transforming the audio recording into a textual transcript in Block S115; accessing a text module and an audio module from a communication module specification, each communication module, in the communication module specification, defining an input prompt and a target output format in Block S120; and prompting the user to upload a voice model for the audio module in Block S154.

In this variation, the system implements methods and techniques described above to prompt the user to select a set of audio modules from a corpus of predefined audio modules and/or to manually enter and select a custom audio module, different from the corpus of predefined communication modules. The system can further receive a set of audio modules or a set of combination modules (e.g., a text module linked to an audio module) and feed the textual transcript and these modules into the language model for transformation of the textual transcript into speech.

### 8.1 Audio Modules+Combination Communication Module

In one implementation, the system implements methods and techniques described above to present a menu within the application defining predefined audio modules representing predefined input prompts and voice models grouped within an audio or sound communication domain. The user may then select multiple predefined audio modules defining input prompts from this menu within the corresponding audio communication domain.

For example, the system can: present a menu within the application defining predefined audio modules defining input prompts and pre-generated voice models corresponding to the audio communication domain. The user may then: review the predefined audio modules in the audio communication domain; and select a first predefined audio module representing a first input prompt, such as “Explain this text to me like a five-year old as a 100-word summary and playback this text as an audio stream with a voice of a five-year old child.”

Alternatively, the system can present a menu within the application defining predefined text modules corresponding to the written communication domain and predefined audio modules corresponding to the audio communication domain. The user may then select multiple predefined text modules and audio modules from this menu. For example, the user may: review the predefined text modules in the text communication domain; select a first predefined text module representing a first input prompt, such as “Explain this text to me like a five-year old as a 100-word summary”; review the predefined audio modules in the audio communication domain; select a predefined audio module representing a second input prompt such as “Playback this text as an audio stream with a voice of a five-year old child”; and generate a combination communication module linking the predefined text module and the predefined audio module. The system can then feed the combination communication module with a textual transcript to the language model to transform the textual transcript into a textual description representing a 100-word summary and generate an audio stream of the 100-word summary in the voice of a five-year old, as further described below.

Additionally, the system can prompt the user to manually enter and select a custom audio module defining an input prompt and a particular voice model a target output format for the language model. In particular, the user may access her user profile and select her voice model for a custom communication module. Alternatively, the user may upload a voice model of a particular person or a particular character that corresponds to the user's audio communication preference. For example, the system can prompt the user to enter and select a custom audio module within the application. The user may upload a voice model associated with a particular actor and an input prompt, such as “Rewrite as a movie script and playback this text as an audio stream with a voice of the particular actor”. The system can implement methods and techniques described below to generate an audio stream of the movie script with the voice of the particular actor and serve the audio stream to the user.

### 8.2 Text-to-Audio Transformation

In one implementation, once the system receives selection of a set of text modules, audio modules, and/or combination modules, the system can: retrieve the textual transcript of the audio recording entered by the user; and feed the textual transcript and the set of text modules, audio modules, and/or combination modules—defining a set of input prompts—into the language model. The language model can then implement methods and techniques described above to interpret the set of text modules, audio modules, and/or combination modules as a set of inputs; and, in response to interpreting the set of text modules, audio modules, and/or combination modules as the set of inputs, automatically generate a textual description according to each input prompt, in parallel, and return a response to the user, via the application executing on the user's device, specifying each textual description. The system can feed the textual description into a text-to-speech generator to output an audio file or an audio stream based on the voice model defined in the audio module or combination module.

For example, the system can: receive selection of a combination communication module, linking a text module and an audio module, and retrieve the textual transcript of an audio recording entered by the user describing a news article. Further, the system can: receive selection of the combination communication module defining a linked input prompt, such as “Explain this text to me like a five-year old as a 100-word summary” and “playback this text as an audio stream with a voice of a five-year old child”; and feed the textual transcript of the news article and the combination communication module into the language model. The language model can: interpret the input prompt defined in the combination communication module as a received input; and, in response to interpreting the received input, automatically generate a textual description representing a summary for a five-year old according to the linked input prompt and return a response to the system specifying the textual description representing a summary for a five-year old. Accordingly, the system can: access a text-to-speech generator; retrieve the voice model, from a predefined menu of voice models, corresponding to the input prompt, such as “voice of a five-year old child”; and feed the textual description representing a summary for a five-year old into the text-to-speech generator to output an audio stream based on the voice model defined in the combination communication module.

Therefore, the system can cooperate with the language model: to receive selection of an audio module or a combination communication module defining an input prompt and a voice model; and to transform the textual transcript into an audio stream with a voice from the corresponding voice model. Thus, by transforming text into an audio stream, the system can enable the user to receive a quick audio stream of content according to the user's audio communication preference. Additionally, the system enables the user to multi-task while listening to the audio stream of content rather than manually reviewing a textual description of the content.

### 9. VIDEO: TEXT-TO-VIDEO TRANSFORMATION

In one variation, Blocks of the first method S100 recite: receiving selection of a video module defining an input prompt and a target output format in Block S120; in response to receiving selection of the video module, prompting the user to upload a face model and a voice model for the video module in Block S154; inserting the textual transcript and the video module into the language model to generate a textual description according to the input prompt and the target output format in Block S164; transforming the textual description into an audio stream based on the voice model in Block S160; extracting a sequence of phonemes from the audio stream in Block 182; retrieving a pre-generated sequence of speech-type facial landmark containers representing motion of the user's face with mouth movements that correspond to generic speech from a user profile associated with the user in Block 184; inserting the sequence of phonemes, the pre-generated sequence of speech-type facial landmark containers, and the face model into a synthetic video generator to generate a video stream of synthetic face images representing the user's predefined expressions and physiognomy in Block S186; and serving the textual description, the audio stream, and the video stream of synthetic face images to the user within the application in Block S170.

In this variation, the system implements methods and techniques described above to receive a set of audio modules or a set of combination modules (e.g., a text module linked to an audio module) and feed the textual transcript and these modules into the language model for transformation of the textual transcript into an audio file or audio stream. The system can further extract speech characteristics from the audio stream for combination with a face model—selected by the user—to generate a video file or video stream of synthetic face images.

In particular, the system can implement methods and techniques described in U.S. patent application Ser. No. 16/870,010, filed on 8 May 2020, to generate a face model of the user's face and store this face model in the user's profile. For example, during a setup period (e.g., prior to an audio recording period), the system can: access a target image of a user; detect a target face in the target image; represent a target constellation of facial landmarks, detected in the target image, in a target facial landmark container; initialize a target set of face model coefficients; generate a synthetic test image based on the target facial landmark container, the target set of face model coefficients, and a synthetic face generator; characterize a difference between the synthetic test image and the target face detected in the target image; adjust the target set of face model coefficients to reduce the difference; and generate a face model, associated with the user, based on the target set of face model coefficients.

The system can further implement methods and techniques described in U.S. patent application Ser. No. 17/681,618, filed on 25 Feb. 2022, to extract speech characteristics (or “phonemes”) from the audio stream; to retrieve the face model from the user's profile and combine the face model and phonemes to generate a video file or video stream of synthetic face images.

### 9.1 Custom Face Model Selection+Text-to-Video Transformation

In one implementation, the system implements methods and techniques described above to present a menu within the application defining predefined video modules representing predefined input prompts, voice models, and face models grouped within a visual or video communication domain. The user may then select multiple predefined video modules defining input prompts from this menu within the corresponding video communication domain.

For example, the system can: present a menu within the application defining predefined video modules defining input prompts, voice models, and face models corresponding to the video communication domain. The user may then: review the predefined video modules in the video communication domain; and select a first predefined video module representing an input prompt, such as “Explain this text to me like a five-year old as a 100-word summary and playback this text as a video stream with a voice of a five-year old child and my face model”. The system then implements methods and techniques described above to transform the textual transcript into an audio stream representing the 100-word summary with the voice of the five-year old child.

Additionally, once the system receives a response from the language model specifying the audio stream, the system can: scan the audio stream at the user's device for speech or speech characteristics (e.g., phonemes); and extract a sequence of phonemes from the audio stream. The system can then: access the user's profile; retrieve the face model associated with the user from the user's profile; retrieve a pre-generated sequence of speech-type facial landmark containers representing motion of the user's face with mouth movements that correspond to generic speech from the user's profile; feed the sequence of phonemes, the pre-generated sequence of speech-type facial landmark containers, and the face model into a synthetic video generator to generate a video file or video stream of synthetic face images representing the user's predefined expressions and physiognomy; and serve the video stream of synthetic face images to the application executing on the user's device.

Alternatively, the system can: scan the audio stream at the user's device for speech or speech characteristics (e.g., phonemes); extract a sequence of phonemes from the audio stream; identify the face model as a custom face model; prompt the user to enter a custom face model, such as a face model of a particular person or a particular animated character; receive selection of the custom face model; retrieve a pre-generated sequence of speech-type facial landmark containers representing motion of the particular person's face with mouth movements that correspond to generic speech from the custom face model; feed the sequence of phonemes, the pre-generated sequence of speech-type facial landmark containers, and the custom face model into a synthetic video generator to generate a video stream of synthetic face images representing the particular person's predefined expressions and physiognomy; and serve the video stream of synthetic face images to the application executing on the user's device.

### 10. VARIATION: CONSTELLATION OF CONCEPTS

In one variation, the system can: access a video file or sequence of frames entered by the user; extract a set of characteristics of the user from the video file and audio recording associated with the video file; represent this set of characteristics as a constellation of concepts; and store this constellation of concepts within the user's profile. Responsive to selection of a module, the system can feed the constellation of concepts and the modules into the language model for transformation of these concepts into a video stream, an audio stream, and/or a textual description.

For example, the system can: receive a sequence of frames depicting the user from the user's profile; interpret an emotion of the user or an intensity of action of a muscle of the user's face based on facial features of the user detected in the sequence of frames; track phonemes spoken by the user while the user exhibits this emotion to detect a set of video characteristics of the user, such as input speech rate, intensity, volume, tone, and/or mood of the user; extract a set of speech characteristics from an audio recording associated with the sequence of frames; represent these video characteristics and speech characteristics as a constellation of concepts; and store this constellation of concepts in the user's profile. The user may then select a video module defining an input prompt, such as “Explain this to a five-year old as a 100-word summary and playback this video file as a video stream with a voice of a five-year old child, my face model, and my body model”. In response to receiving selection the video module, the system can feed the constellation of concepts and the video module into the language model for transformation of the constellation of concepts into to a video file or video stream of synthetic face and body images representing the user's predefined expressions and physiognomy; and serve the video stream of synthetic face and body images to the application executing on the user's device.

Thus, the system can represent characteristics from an audio recording or a video file uploaded by the user as a constellation of concepts and feed the constellation of concepts and modules selected by the user into the language model to transform the constellation of concepts into a video stream, an audio stream, and/or a textual description rather than transforming an audio recording into a textual transcript and feeding the textual transcript and selected modules into the language model to transform the textual transcript into a video stream, an audio stream, and/or a textual description.

### 11. OUTBOUND COMMUNICATIONS BASED ON USER PREFERENCES

In one variation, the system can transform outbound communications into an output (or a set of outputs) of varying formats for a recipient (or a set of recipients), as shown in FIGS. 2B and 2C. In particular, in this variation, the system can: access an outbound message (e.g., an audio recording) in a first format captured by the user; identify the recipient associated with the outbound message; access user preferences defining target language signals (e.g., key details enumerated in the audio recording) and/or target user characteristics (e.g., contextual information about the user) to present to the recipient based on the identity of the recipient (e.g., a client); extract these target language signals and/or user characteristics from the outbound message and/or an external database (e.g., an online networking platform); and identify a target output format for transforming the target language signals and/or user characteristics into—for presentation to the recipient—based on the identity of the recipient. In particular, the system can access user preferences and identify the target output format in response to absence of selection of a custom and/or predefined communication module from the user.

The system can then: transform these target language signals and/or user characteristics into an output in the target output format (e.g., transform key details in fully-punctuated prose from the email into a bulleted-list); and serve the output to the user. In particular, the system can identify the target output format specifying a second format different from the first format of the outbound message.

### 12. RECIPIENT IDENTIFIER+RECIPIENT CLASS

In one variation, Blocks of the first method S100 recite: retrieving a recipient identifier of a recipient associated with the outbound message in Block S114; and identifying a class of the recipient based on the recipient identifier in Block S118. Generally, the system can: identify the recipient (and the class of the recipient) associated with an outbound message based on a recipient identifier (e.g., an email address) of the recipient.

In one implementation, the system can: access an outbound message (e.g., an audio recording); retrieve a recipient identifier (e.g., a contact name) of the recipient associated with the outbound message; and identify a class (e.g., a familial class) of the recipient based on the recipient identifier. The system can then identify a target output format, target language signals, and/or target user characteristics to present to the recipient based on the class of the recipient, as described in detail below. Therefore, the system can identify the recipient and the class of the recipient to personalize the output for the recipient based on the preferred communication mode and/or style of the user when rendering outbound content for a particular class.

### 13. TARGET LANGUAGE SIGNALS+TARGET USER CHARACTERISTICS

In one variation, Blocks of the first method S100 recite: accessing a set of user preferences defining a set of target language signals and a set of target user characteristics to present to the recipient based on the class of the recipient in Block S120; extracting the set of target language signals from the outbound message in Block S130; and retrieving the set of target user characteristics from an external database based on the recipient identifier and the set of user preferences in Block S136.

Generally, in Block S120, the system can access user preferences that define: target language signals (e.g., a professional tone, a set of phrases) that convey the intent and/or purpose of the outbound message; and target user characteristics (e.g., a position title of the user, historical interaction data) that present context about the user and relevance to the content of the outbound message. In particular, the user preferences can define target language signals and/or target user characteristics specific to different classes of senders.

In one implementation, the system can implement methods and techniques described above to: access an outbound message captured by the user and identify a class of the recipient associated with the outbound message; and access a set of user preferences defining a set of target language signals and a set of target user characteristics to present to the recipient based on the class of the recipient. The system can then: extract the set of target language signals from the outbound message; and retrieve the set of target user characteristics from an external database based on the recipient identifier and the set of user preferences.

In particular, the system can: identify a set of language signals (e.g., each word, phrase, or contextual element) in the outbound message; extract the set of target language signals (e.g., a subset of the set of language signals); and retrieve the set of target user characteristics from the external database in response to absence of the target user characteristics in the set of language signals and/or the set of target language signals. For example, the system can: identify a set of phrases in an outbound message and a name of the recipient associated with the outbound message; and, in response to absence of a professional background summary (i.e., a target user characteristic) in the set of phrases, access the professional background summary from an online networking platform (e.g., from a profile associated with the user).

Accordingly, the system can: extract target language signals from the outbound message to capture essential information that conveys the intent or purpose of the outbound message; and/or retrieve target user characteristics (e.g., from the outbound message, from an external database) that present context (i.e., about the user) that is relevant to the outbound message. Therefore, the system can integrate relevant information from the outbound message and/or contextual details about the user to enhance the clarity and/or relevance of the output for the user.

### 14. TARGET OUTPUT FORMAT BASED ON RECIPIENT CLASS

In one variation, Blocks of the first method S100 recite: accessing an outbound message in a first format, captured by a user via a voice recorder integrated in an application executing on a computer system in Block Silo; accessing a recipient list assigning target output formats to outbound messages for classes of recipients in Block S140; and identifying a target output format, different from the first format, for the set of target language signals and the set of target user characteristics based on the class of the recipient and the recipient list in Block S150.

Generally, in Block S150, the system can: identify a target output format for the outbound message (e.g., communication mode and/or style) according to user preference when rendering information from a particular recipient class. More specifically, the system can identify the target output format specifying the communication mode (e.g., written) and the communication style, such as an order of content (e.g., actionable item descriptions ordered at the end), a tone (e.g., a professional tone), a content limit (e.g., a word count limit), etc.

For example, the system can: implement methods and techniques described above to access an audio recording captured by the user and identify a clientele class of the recipient associated with the audio recording; and identify the target output format specifying an email based on the clientele class of the recipient. In particular, in this example the system can identify the target output format specifying the email: including fully-punctuated prose, written in a professional tone, and including actionable item descriptions ordered at the end of the email. Alternatively, the system can identify the target output format based on a selection specifying the target output format received from the user. Thus, the system dynamically tailors the transformation of outbound messages to align with the communication preferences of the user for different recipient classes.

### 15. OUTPUT GENERATION

In one variation, Blocks of the first method S100 recite: transforming the set of target language signals and the set of target user characteristics into an output in the target output format in Block S160; and serving the output to the user in Block S170. Generally, the system can implement natural language processing techniques: to interpret the set of target language signals and the set of target user characteristics; to generate an output in the target output format responsive to the inbound message; and to serve the output to the application executing on a user's device.

In one implementation, the system can implement methods and techniques described above to: access an outbound message captured by the user; extract a set of target language signals from the outbound message; retrieve a set of target user characteristics; and identify a target output format for the set of target language signals and the set of target user characteristics based on a class of the recipient.

In particular, in this implementation, the system can extract the set of target language signals including a set of phrases. The system can then transform the set of target language signals and the set of target user characteristics into the output by: excluding a set of nonessential phrases (e.g., redundant phrases), in the set of phrases in the set of target language signals, from the output; preserving a set of essential phrases (e.g., specific dates and times of events), in the set of phrases in the set of target language signals, in the output; transforming a set of transformable phrases (e.g., details of a story), in the set of phrases in the set of target language signals, into a second set of target language signals; and compiling the set of essential phrases and the second set of target language signals into the output.

Therefore, the system can interpret and refine target language signals and user characteristics from an outbound message to generate an output for the recipient that preserves critical details, such as dates and times, and adapts transformable phrases, such as narrative elements, to enhance clarity and/or relevance of the outbound message.

### 16. VARIATION: MODEL-DEFINED TARGET LANGUAGE SIGNALS+TARGET OUTPUT FORMAT

In one variation, the system can implement methods and techniques described above: to access an outbound message captured by the user and identify a class of the recipient associated with the outbound message; and to extract a set of language signals from the outbound message. The system can then: generate a prompt including the set of language signals, and the recipient class; transmit the prompt to a remote server executing a language model; and receiving an output from the remote server responsive to the prompt, the output specifying a set of target language signals and a target output format. In this variation, the system can autonomously learn user preferences and store these user preferences (e.g., target language signals, or target output formats) in the model for future output generation.

### 17. EXAMPLE: OUTBOUND LECTURE RECORDING+MULTIPLE OUTPUT FORMATS

In one example, the system: accesses an audio recording (i.e., an outbound audio message) of an educational lecture captured by a professor for a set of students (i.e., a set of recipients) taught by the professor; identifies key details in the audio recording and relevant contextual details about the user; and transforms the key details and relevant contextual details into different outputs for the set of students. In particular, in this example, the system transforms the audio recording into different outputs for students enrolled in an accelerated version of a course and students enrolled in a non-accelerated version of the course.

In this example, the system: identifies an accelerated student class of a first student; and, based on the accelerated student class of the first student, accesses a first set of user preferences defining a first set of target language signals including a set of lecture highlights. The system then: extracts a set of phrases and the set of lecture highlights from the audio recording; identifies a target output format specifying a lecture summary organized by section headings based on the accelerated student class of the first student; and transforms the set of target language signals into the lecture summary.

Additionally, in this example, the system: identifies a non-accelerated student class of a second student; and, based on the non-accelerated student class of the second student, accesses a second set of user preferences defining a second set of target language signals including the set of lecture highlights, a set of study recommendations, and a set of vocabulary terms and definitions. The system then: extracts a set of phrases, the set of lecture highlights, the set of study recommendations, and the set of vocabulary terms and definitions from the audio recording; identifies a target output format specifying a set of flashcards based on the non-accelerated student class of the first student; and transforms the set of target language signals into the set of flashcards.

Additionally, in this example, the system: accesses a set of target user characteristics including historical interaction data between the professor and the students; in response to absence of historical interaction data (e.g., previous email correspondence), retrieves an introduction and a professional background summary of the professor from an online platform (e.g., the professor's website); and transforms the introduction and the professional background summary into the output.

Accordingly, in this example, the system: transforms the same content (i.e., the single audio recording of the educational lecture) into multiple outputs in different target formats based on the student classes; and includes context about the professor upon detecting initial or limited engagement between the professor and the students (e.g., at the beginning of a semester).

### 18. EXAMPLE: OUTBOUND AUDIO RECORDING+TEXT MESSAGE OUTPUT

In one example, the system: accesses an audio recording (i.e., an outbound audio message) captured by a user that describes a recent vacation taken by the user; and transforms key details from the audio recording and relevant contextual details about the user into a text message.

In this example, the system: identifies a personal contact class of the recipient; and, based on the personal contact class of the recipient, accesses a set of user preferences defining a set of target language signals including phrases describing significant life events of the user (e.g., descriptions of recent trips or life milestones), and a set of target user characteristics including recent social media activity data, such as posts recently shared by the user that relate to these significant life events (e.g., photos or anecdotes recently shared by the user that relate to recent trips or life milestones). The system then: extracts a set of phrases describing the recent vacation from the audio recording; extracts a set of social media activity data related to the recent trip from an online social media platform (i.e., from an account associated with the user on the online social media platform); and transforms the set of phrases and the set of social media data into a text message for the recipient. Thus, in this example, the system integrates and transforms content from the audio recording and context from a social media profile of the user into a text message tailored to the recipient that preserves the original intent or purpose of the audio recording, while supplementing the audio recording with additional context.

### 19. EXAMPLE: OUTBOUND AUDIO RECORDING+TO-DO LIST OUTPUT

In one example, the system: accesses an audio recording captured by a manager that includes a message to an employee supervised by the manager; and transforms key details from the audio recording into a to-do list for the employee (i.e., the recipient). In this example, the system: identifies an employee of the recipient; based on the employee class of the recipient, accesses a set of user preferences defining a set of target language signals including phrases describing action items; extracts a set of phrases describing the action items from the audio recording; and transforms the set of phrases into a to-do list for the employee. For example, the system can: extract a set of phrases (e.g., “what's the latest update on the Marketing Campaign Project,” “I need updates to present at the meeting on Friday”) from the audio recording; and transform the set of phrases into the to-do list accordingly (e.g., “send status update on the Marketing Campaign Project to Jane by Friday”). Thus, in this example, the system filters and transforms content from the audio recording into a to-do list tailored to the employee, thereby enabling the manager to quickly record instructions or tasks for the employee without the need to organize or structure these ideas.

### 20. SECOND METHOD: CONTEXTUAL INBOUND COMMUNICATION TRANSFORMATION

As shown in FIGS. 2A, 2D, and 2E, a second method S200 includes: accessing an inbound textual message in a first format, sent to a user, and accessed by the user via an application executing on the computer system in Block S210; retrieving a sender identifier of a sender associated with the inbound textual message in Block S214; and identifying a class of the sender based on the sender identifier in Block S218.

The second method S200 also includes: accessing a set of user preferences defining a set of target language signals and a set of target sender characteristics to present to the user based on the class of the sender in Block S220; extracting the set of target language signals from the inbound textual message in Block S230; retrieving the set of target sender characteristics from an external database based on the sender identifier and the set of user preferences in Block S236; accessing a sender specification assigning target output formats to inbound messages from classes of senders in Block S240; and identifying a target output format, different from the first format, for the set of target language signals and the set of target sender characteristics based on the class of the sender and the sender specification in Block S250.

The second method S200 also includes: transforming the set of target language signals and the set of target sender characteristics into an output in the target output format in Block S260; and serving the output to the user in Block S270.

### 21. APPLICATIONS

Generally, Blocks of the second method S200 can be executed by a computer system (e.g., a remote computer system, a computer network, a remote server) in conjunction with an application (e.g., a native or web application) (hereinafter “the system”): to access inbound content—such as an audio recording, a writing sample, or a textual description—sent to a user and accessed by the user via an instance of the application executing on a computing device (e.g., a smartphone, a tablet, a laptop computer, a desktop computer) accessed by the user; to identify a target output format based on a class of the sender associated with the inbound content; to retrieve sender characteristics associated with the sender based on the user's preferences; and to transform the inbound content and the sender characteristics into an output in the target output format.

For example, the user may manually enter an inbound message and a hyperlink of corresponding inbound content (e.g., an email, a text message, a social media post, a book, a research paper, a podcast recording, an informational video, a radio recording). The system can then retrieve characteristics about the sender, such as the sender's recent social media activity, professional background, shared interests with the user, or geographical location. The system can then transform this inbound content and the retrieved characteristics about the sender into the user's communication preference (e.g., written communication, audio communication, video communication).

Accordingly, Blocks of the second method S200 can be executed by the system: to automatically transform inbound content (e.g., an audio recording, a written description) and sender characteristics into a new textual description, audio stream, and/or video stream according to the target output format; and to serve the new textual description, audio stream, and/or video stream to the user within the application. Therefore, the system can integrate relevant information from the inbound message and/or contextual details about the sender to enhance the clarity and/or relevance of the output for the user.

### 22. INBOUND MESSAGE TRANSFORMATION

In one implementation, as shown in FIGS. 2D and 2E, the system can: access an inbound message (e.g., an email) in a first format (e.g., fully-punctuated prose) sent to the user; identify the sender associated with the inbound message; access user preferences defining target language signals (e.g., key details enumerated in the email) and/or target sender characteristics (e.g., contextual information about the sender) to present to the user based on the identity of the sender (e.g., a client); extract these target language signals and/or sender characteristics from the inbound message and/or an external database (e.g., an online networking platform); and identify a target output format for the target language signals and/or sender characteristics based on the identity of the sender. In particular, the system can access user preferences and identify the target output format in response to absence of selection of a custom and/or predefined communication module from the user.

The system can then: transform these target language signals and/or sender characteristics into an output in the target output format (e.g., transform key details in fully-punctuated prose from the email into a bulleted-list); and serve the output to the user. In particular, the system can identify the target output format specifying a second format different from the first format of the inbound message.

In one example, the system can access an inbound message service text message in a first format specifying: a first text format (e.g., block text); a first content order (e.g., a list of questions ordered first, and a story ordered second); and a first level of abstraction (e.g., expanded content). In this example, the system can identify the target output format including a bulleted-list summary specifying: a second text format different from the first text format (e.g., a bulleted-list); a second content order different from the first content order (e.g., the story ordered first and the list of questions ordered second); and a second level of abstraction different from the first level of abstraction (e.g., a content summary).

In another example, the system can access an inbound email in a first format characterized by: a first language complexity (e.g., advanced vocabulary and technical terminology); and a first tone (e.g., a professional tone). In this example, the system can identify the target output format including a podcast specifying: a second language complexity different from the first language complexity (e.g., simplified language and common terminology); and a second tone (e.g., a comedic tone).

Accordingly, the system can transform inbound messages into unique and/or personalized outputs for the user, thereby enhancing content engagement by enabling the user to review inbound content in the preferred communication mode and/or style of the user.

### 23. INBOUND MESSAGE ACCESS

Block S210 of the second method S200 recites accessing an inbound textual message in a first format, sent to a user, and accessed by the user via an application executing on the system. Generally, in Block S210, the system can access an inbound communication (or a set of inbound communications) in a first format, such as an inbound textual message, or an inbound audio recording. For example, the system can access: an inbound message service text message sent to the user by a sender; a set of inbound emails sent to the user by a set of senders; and/or a set of direct messages sent to the user by a set of senders (e.g., via one or more direct messaging applications executing on the system). The system can then transform the inbound communication(s) into an output—in a second format different from the first format—according to a preferred communication mode and/or style of the user, as described in detail below.

### 24. SENDER IDENTIFIER+SENDER CLASS

Blocks of the second method S200 recite: retrieving a sender identifier of a sender associated with the inbound textual message in Block S214; and identifying a class of the sender based on the sender identifier in Block S218. Generally, the system can: identify the sender (and the class of the sender) associated with an inbound message based on a sender identifier (e.g., an email address) of the sender.

In one implementation, the system can: access an inbound message (e.g., a message service text message); retrieve a sender identifier (e.g., a contact name) of the sender associated with the inbound message; and identify a class (e.g., a familial class) of the sender based on the sender identifier. The system can then identify a target output format, target language signals, and/or target sender characteristics to present to the user based on the class of the sender. Therefore, the system can identify the sender and the class of the sender to personalize the output for the user based on the preferred communication mode and/or style when reviewing inbound content from senders of a particular class.

### 25. TARGET LANGUAGE SIGNALS+TARGET SENDER CHARACTERISTICS

Blocks of the second method S200 recite: accessing a set of user preferences defining a set of target language signals and a set of target sender characteristics to present to the user based on the class of the sender in Block S220; extracting the set of target language signals from the inbound textual message in Block S230; and retrieving the set of target sender characteristics from an external database based on the sender identifier and the set of user preferences in Block S236.

Generally, in Block S220, the system can access user preferences that define: target language signals (e.g., a professional tone, a set of phrases) that convey the intent and/or purpose of the inbound message; and target sender characteristics (e.g., a position title of the sender, historical interaction data) that present context about the sender and relevance to the content of the inbound message. In particular, the user preferences can define target language signals and/or target sender characteristics specific to different classes of senders.

In one implementation, the system can: implement methods and techniques described above to access an inbound message sent to the user and identify a class of the sender associated with the inbound message; and access a set of user preferences defining a set of target language signals and a set of target sender characteristics to present to the user based on the class of the sender. The system can then: extract the set of target language signals from the inbound message; and retrieve the set of target sender characteristics from an external database based on the sender identifier and the set of user preferences. In one example, the system can: identify a set of phrases in a body of an email and a name of the sender associated with the email; and, in response to absence of a position title (i.e., a target sender characteristic) in the set of phrases, access the position title from an online networking platform.

Accordingly, the system can: extract target language signals from the inbound message to capture essential information that conveys the intent or purpose of the inbound message; and/or retrieve target sender characteristics (e.g., from the inbound message, from an external database) that present context (i.e., about the sender) that is relevant to the inbound message. Therefore, the system can integrate relevant information from the inbound message and/or contextual details about the sender to enhance the clarity and/or relevance of the output for the user.

### 26. TARGET OUTPUT FORMAT BASED ON SENDER CLASS

Blocks of the second method S200 recite: accessing an inbound message in a first format, sent to a user, and accessed by the user via an application executing on the system in Block S210; accessing a sender specification assigning target output formats to inbound messages from classes of senders in Block S240; and identifying a target output format, different from the first format, for the set of target language signals and the set of target sender characteristics based on a class of the sender and the sender specification in Block S250. Generally, in Block S250, the system can: identify a target output format for the inbound message (e.g., communication mode and/or style) according to user preference when reviewing information from a particular sender class.

### 26.1 Variation: Target Output Format Based on Historical Communications

In one variation, the system can identify the target output format based on target output formats associated with historical communications between the user and the sender and/or users of the same class. In particular, in this variation, the system can implement methods and techniques described above to: access an inbound message sent to the user; identify a class of the sender associated with the inbound message; and access a set of outputs generated in response to receipt of inbound messages sent to the user by senders associated with the class of the sender, each output in the set of outputs associated with an output format in a set of output formats. The system can then, for each output format in the set of output formats: identify a quantity of outputs in the set of outputs associated with the output format; and define the target output format as a first output format in the set of output formats associated with a maximum quantity of outputs.

In one example, in response to accessing an inbound email sent to the user by a sender associated with a clientele class, the system can: access a set of ten outputs generated in response to receipt of inbound emails sent to the user by senders associated with the clientele class; identify a quantity of eight bullet-pointed lists in the set of outputs; identify a quantity of two full prose summaries in the set of outputs; and define the target output format as a bullet-pointed list.

Thus, in this variation, the system can define the target output format based on historical outputs generated for similar inbound messages (i.e., based on sender class) to ensure the output is generated in a communication mode and/or style proven effective for the user when reviewing content from this sender class.

### 26.2 Variation: User Preferences Based on User State

Generally, in Block S266 of the second method S200, the computer system can interpret the state of the user to identify the target output format. In one implementation the computer system can: access a calendar application associated with the user and executing on the computer system; identify a forecast time period corresponding to user availability and represented in the calendar application; and derive a content limit for the output based on the forecast time period. In this implementation, the system can identify the target output format based on the current state of the user, such as time availability, location, current emotional state, or concurrent activities (e.g., driving or exercising). In particular, in this variation, the system can: implement methods and techniques described above to: access an inbound message sent to the user and identify a class of the sender associated with the inbound message; interpret a current state of the user; and identify the target output format based on the class of the sender, the sender specification, and the current state of the user.

In one example, the system can: implement methods and techniques described above to access a set of unread, inbound message service text messages sent to the user (e.g., between 3:00 PM and 4:00 PM); identify a familial class of the set of senders; access a calendar application associated with the user and executing on the system; identify a forecast time period (e.g., between 5:30 PM and 5:30 PM on the same day) corresponding to availability of the user (e.g., during an evening commute of the user) and represented in the calendar application; derive a content limit (e.g., 30 minutes) for the output based on the forecast time period; and identify the target output format specifying a podcast based on the familial class, the sender specification, and the content limit. Alternatively, in response to absence of availability of the user and/or identifying a forecast time period with insufficient time for the user to listen to the podcast, the system can identify an alternative target output format specifying a bulleted-list summary.

Accordingly, the system can: interpret the state of the user to identify the target output format; prioritize selecting a preferred target output format (e.g., transforming inbound message service text messages from family members into an expanded, story-driven podcast) when the state of the user indicates sufficient availability and/or practicality; and select an alternative target output format (e.g., transforming inbound message service text messages from family members into a concise summary) when the state of the user indicates a constraint (e.g., limited time or high activity level). Thus, in this variation, the system can define the target output format specifying a particular communication mode and/or style based on the current state of the user to ensure the output is accessible and/or engaging for the user.

### 27. OUTPUT GENERATION

Blocks of the second method S200 recite: transforming the set of target language signals and the set of target sender characteristics into an output in the target output format in Block S260; and serving the output to the user in Block S270. Generally, the system can implement natural language processing techniques: to interpret the set of target language signals and the set of target sender characteristics; to generate an output in the target output format responsive to the inbound message; and to serve the output to the application executing on a user's device.

In one implementation, the system can implement methods and techniques described above to: access an inbound message sent to the user; extract a set of target language signals from the inbound message; retrieve a set of target sender characteristics of the sender; and transform the set of target language signals and the set of target sender characteristics into the output in the target output format. Therefore, the system can interpret and refine target language signals and sender characteristics from an inbound message to generate a customized output for the user that preserves critical details, such as dates and times, and adapts transformable phrases, such as narrative elements, to enhance clarity and/or relevance of the inbound message.

### 28. EXAMPLE: INBOUND EMAIL+TO-DO LIST OUTPUT

In one example, the system: accesses an inbound email (i.e., an inbound textual message) sent to the user by a client (i.e., the sender); identifies actionable requests in the inbound email and relevant contextual details about the client; and transforms the actionable requests and relevant contextual details into a to-do list (i.e., the output) for the user.

In this example, the system: identifies a clientele class of the sender based on an email address of the client; accesses the set of user preferences defining a set of target sender characteristics including a position title and a clientele description; and extracts a set of phrases from a body of the email and the position title of the sender from a signature in the email. In particular, in this example, in response to absence of the clientele description in the inbound email, the system retrieves the clientele description from an online networking platform (i.e., an external database). The system then: identifies a target output format specifying a to-do list based on the clientele class; and transforms the set of phrases, the position title, and the clientele description into the to-do list.

In particular, the system transforms the set of target language signals and the set of target sender characteristics into the to-do list by: excluding a set of nonessential phrases (e.g., salutations and closing remarks) from the to-do list; preserving a set of essential phrases (e.g., project names and project deadlines) and the position title of the client in the to-do list; transforming a set of transformable phrases (e.g., actionable requests) and the clientele description into a second set of target language signals; and compiling the set of essential phrases and the second set of target language signals into the to-do list. Thus, in this example, the system filters and transforms content from the inbound email into a to-do list, thereby enabling the user to access essential information from the inbound email (e.g., actionable requests) in a simplified, task-oriented output format preferred by the user.

### 29. EXAMPLE: SET OF INBOUND EMAILS+PODCAST OUTPUT

In one example, the system: accesses inbound emails sent to the user by a set of coworkers (i.e., a set of senders); identifies actionable requests in the inbound emails and relevant contextual details about the set of coworkers; and transforms the actionable requests and relevant contextual details into a to-do list for the user.

In this example, the system: accesses a set of inbound emails sent to the user; and, for each inbound email in the set of inbound emails, identifies a class of the sender based on an email address of the sender. The system then: identifies a subset of emails in the set of inbound emails, sent to the user within a predefined time period by the set of coworkers associated with a coworker class; and accesses a set of user preferences defining a set of target language signals including a set of action item descriptions, and a set of target sender characteristics including a set of position titles.

The system then compiles a set of composite language signals of the subset of emails by: compiling phrases from a body of each inbound email into a set of phrases; compiling action item descriptions from each inbound email into the set of action item descriptions; and compiling position titles from each inbound email into the set of position titles. The system then: identifies a target output format specifying a podcast based on the coworker class; and transforms the set of phrases, the set of action item descriptions, and the set of position titles into the podcast. Thus, in this example, the system filters and transforms content from a subset of inbound emails from a coworker class into a podcast-style output, thereby enabling the user to access essential information from the inbound emails (e.g., actionable requests) in an engaging auditory format preferred by the user.

### 30. EXAMPLE: INBOUND EMAILS+SOCIAL MEDIA-STYLE OUTPUT

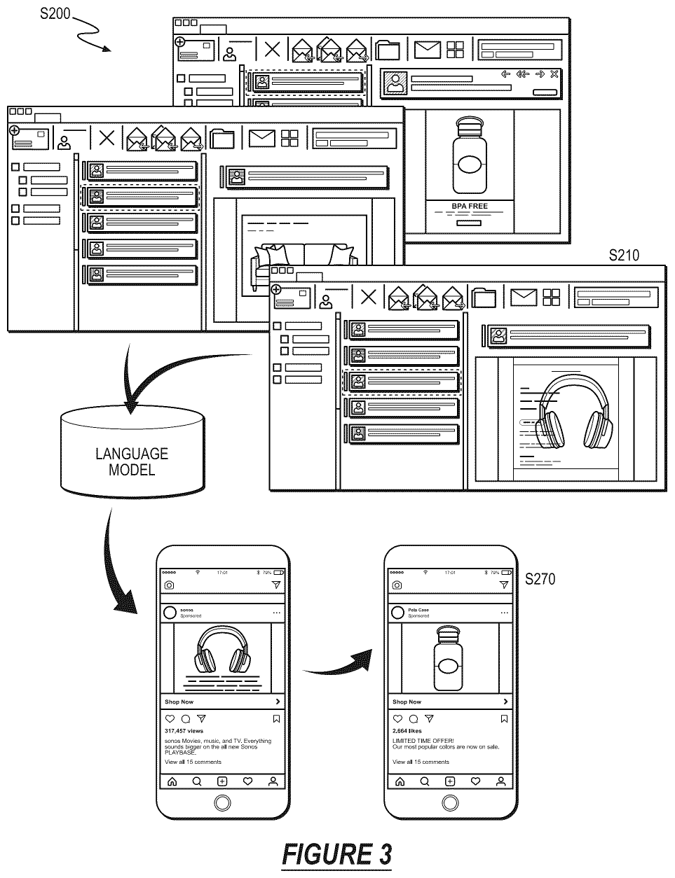

In one example, as shown in FIG. 3, the system: accesses inbound emails sent to the user by a set of retailers; identifies product names in the inbound emails and relevant contextual details about the set of retailers; and transforms the product names and relevant contextual details into a social-media style feed including product descriptions for each identified product.

In this example, the system: identifies a subset of emails in a set of inbound emails, sent to a user within a predefined time period by the set of retailers associated with a retailer class; accesses a set of user preferences defining a set of target language signals including a set of product names and a set of product descriptions, and a set of target sender characteristics including a set of retailer names.

The system then compiles a set of composite language signals of the subset of emails by: compiling phrases from a body of each inbound email into a set of phrases; compiling product names from each inbound email into the set of product names; and compiling retailer names from each inbound email into the set of retailer names. In this example, in response to absence of the set of product descriptions in the subset of emails, the system retrieves the set of product descriptions from a set of external databases. In particular, for each product name extracted from the subset of emails, the system retrieves a product description corresponding to the product name from an online retailer platform associated with the retailer. For example, the system can access a product description by accessing a hyperlink included in an inbound email and associated with the product name.

The system then: identifies a target output format specifying a social media-style feed based on the retailer class of the set of senders; and transforms the set of composite language signals and the set of target sender characteristics into the social media-style feed. In particular, in this example, for each product name in the set of product names, the system calculates a relevance score for the product name based on a correlation between the product name and a user interaction history associated with the product name (e.g., prior product views, clicks, or purchases). Alternatively, the system can calculate a relevance score for the product name based on a retailer rating, a user preference score associated with product categories, and/or a frequency of occurrence of the product name across the subset of emails. The system then orders the set of product names into a ranked list based by descending relevance scores. Thus, in this example, the system filters and transforms content from a subset of inbound emails from a retailer class into a social media-style feed, thereby prioritizing presentation of product information tailored to interests and preferences of the user.

### 31. EXAMPLE: INBOUND MESSAGE SERVICE TEXT MESSAGE+SUMMARY OUTPUT

In one example, the system: accesses an inbound message service text message (or “text message”) sent to the user by a relative; identifies a personal story in the inbound text message and relevant contextual details about the relative; and transforms the personal story and relevant contextual details into a content summary for the user.

In this example, the system: identifies a familial class of the sender based on a contact name of the relative associated with the text message; accesses the set of user preferences defining a set of target sender characteristics including a set of social media activity data; and extracts a set of phrases from the message service text message. In particular, in this example, in response to absence of the set of social media activity data in the text message, the system retrieves the set of social media activity data from an online social networking platform.

The system then: identifies a target output format specifying a content summary associated with a word limit (e.g., a 50-word limit) based on the familial class of the sender; and transforms the set of target language signals and the set of target sender characteristics into the content summary.

In particular, the system transforms the set of target language signals and the set of target sender characteristics into the content summary by: excluding a set of nonessential phrases (e.g., extraneous phrases unrelated to the personal story) from the content summary; preserving a set of essential phrases (e.g., specific names and dates related to the personal story) in the content summary; transforming a set of transformable phrases (e.g., an emotional state or opinion of the sender) and the set of social media activity data into a second set of target language signals; and compiling the set of essential phrases and the second set of target language signals into the content summary.

Thus, in this example, the system filters and transforms content from the text message into a content summary, thereby enabling the user to access essential information from the text message (e.g., significant events or key updates from the sender) in addition to contextual details without the need to read the entire text message and/or access a social media profile of the sender.

### 32. CONCLUSION

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, virtual reality headset, in-vehicle infotainment system, robot, unmanned aerial vehicle, autonomous vehicle, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
accessing an inbound textual message in a first format, sent to a user, and accessed by the user via an application executing on a computer system;
retrieving a sender identifier of a sender associated with the inbound textual message;
identifying a class of the sender based on the sender identifier;
accessing a set of user preferences defining a set of target language signals and a set of target sender characteristics to present to the user based on the class of the sender;
retrieving the set of target sender characteristics from an external database based on the sender identifier and the set of user preferences;
accessing a sender specification assigning target output formats to inbound messages from classes of senders;
identifying a target output format, different from the first format, for the set of target language signals and the set of target sender characteristics based on the class of the sender and the sender specification;
extracting the set of target language signals from the inbound textual message;
transforming the set of target language signals and the set of target sender characteristics into an output in the target output format; and
serving the output to the user.

2. The method of claim 1:
wherein extracting the set of target language signals comprises extracting the set of target language signals from the inbound textual message at the computer system; and
wherein transforming the set of target language signals and the set of target sender characteristics into the output in the target output format comprises:
generating a prompt comprising:
the set of target language signals;
the set of target sender characteristics; and
the target output format;
transmitting the prompt to a remote server executing a language model; and
receiving the output from the remote server responsive to the prompt.

3. The method of claim 1:
wherein accessing the inbound textual message comprises accessing the inbound textual message comprising an email;
wherein retrieving the sender identifier comprises retrieving an email address;
wherein identifying the class of the sender comprises identifying the class comprising a clientele class of the sender based on the email address;
wherein accessing the set of user preferences comprises accessing the set of user preferences defining the set of target sender characteristics comprising a position title and a clientele description;
wherein retrieving the set of target sender characteristics comprises:
retrieving the clientele description from the external database comprising an online networking platform;
wherein identifying the target output format comprises identifying the target output format specifying:
a to-do list;
wherein extracting the set of target language signals comprises extracting:
a set of phrases from a body of the email; and
the position title of the sender from a signature in the email; and
wherein transforming the set of target language signals and the set of target sender characteristics into the output comprises:
excluding a set of nonessential phrases, in the set of phrases in the set of target language signals, from the output;
preserving a set of essential phrases, in the set of phrases in the set of target language signals, and the position title of the sender in the output;
transforming a set of transformable phrases, in the set of phrases in the set of target language signals, and the clientele description into a third set of target language signals; and
compiling the set of essential phrases and the third set of target language signals into the to-do list.

4. The method of claim 1, further comprising:
accessing a set of inbound textual messages comprising a set of emails;
for each email in the set of emails:
retrieving the sender identifier comprising an email address of the sender associated with the email; and
identifying the class of the sender based on the email address;
identifying a subset of emails in the set of emails, sent to the user within a predefined time period by a set of senders associated with a coworker class;
accessing a second set of user preferences defining a second set of target language signals and a second set of target sender characteristics to present to the user based on the coworker class of the set of senders:
the second set of target language signals comprising a set of action item descriptions; and
the second set of target sender characteristics comprising a set of position titles;
compiling a set of composite language signals of the subset of emails by:
compiling phrases from a body of each email into a set of phrases;
compiling action item descriptions from each email into the set of action item descriptions; and
compiling position titles from each email into the set of position titles;
identifying a second target output format comprising a podcast for the set of composite language signals and the second set of target sender characteristics based on the coworker class and the sender specification; and
transforming the set of composite language signals and the second set of target sender characteristics into the podcast by:
excluding a set of nonessential phrases, in the set of phrases in the set of composite language signals, from the output;
preserving a set of essential phrases, in the set of phrases in the set of composite language signals, and the set of position titles in the output;
transforming a set of transformable phrases, in the set of phrases in the set of composite language signals and the set of action item descriptions into a third set of target language signals; and
compiling the set of essential phrases and the third set of target language signals into the podcast.

5. The method of claim 1:
wherein accessing the inbound textual message comprises accessing the inbound textual message comprising a message service text message;
wherein retrieving the sender identifier comprises retrieving a contact name of the sender;
wherein identifying the class of the sender comprises identifying the class comprising a familial class of the sender;
wherein accessing the set of user preferences comprises accessing the set of user preferences defining the set of target sender characteristics comprising a set of social media activity data;
wherein retrieving the set of target sender characteristics comprises retrieving the set of social media activity data from the external database comprising an online social networking platform;
wherein identifying the target output format comprises identifying the target output format specifying a content summary associated with a word limit;
wherein extracting the set of target language signals comprises extracting a set of phrases from the message service text message; and
wherein transforming the set of target language signals and the set of target sender characteristics into the output comprises:
excluding a set of nonessential phrases, in the set of phrases in the set of target language signals, from the output;
preserving a set of essential phrases, in the set of phrases in the set of target language signals, in the output;
transforming a set of transformable phrases, in the set of phrases in the set of target language signals, and the set of social media activity data into a second set of target language signals; and
compiling the set of essential phrases and the second set of target language signals into the content summary.

6. The method of claim 1, further comprising:
accessing a set of inbound textual messages comprising a set of emails;
for each email in the set of emails:
retrieving the sender identifier comprising an email address of the sender associated with the email; and
identifying the class of the sender based on the email address;
identifying a subset of emails in the set of emails, sent to the user within a predefined time period by a set of senders associated with a retailer class;
accessing a second set of user preferences defining a second set of target language signals and a second set of target sender characteristics to present to the user based on the retailer class of the set of senders:
the second set of target language signals comprising a set of product names; and
the second set of target sender characteristics comprising a set of retailer names;
compiling a set of composite language signals representing a set of phrases, the set of product names, and the set of retailer names extracted from the subset of emails;
identifying a second target output format comprising a social media-style feed for the set of composite language signals and the second set of target sender characteristics based on the retailer class and the sender specification; and
transforming the set of composite language signals and the second set of target sender characteristics into the social media-style feed by:
for each product name in the set of product names, calculating a relevance score for the product name based on a correlation between the product name and a user interaction history associated with the product name; and
ordering the set of product names into a ranked list based on corresponding relevance scores.

7. The method of claim 6:
wherein accessing the second set of user preferences comprises accessing the second set of user preferences defining:
the second set of target language signals comprising the set of product names and a set of product descriptions; and
further comprising, in response to absence of the set of product descriptions in the set of composite language signals:
for each product name in the set of product names, retrieving a product description corresponding to the product name from an online retailer platform associated with the sender.

8. The method of claim 1:
wherein accessing the set of user preferences comprises accessing the set of user preferences defining a first target sender characteristic;
further comprising scanning the set of target language signals for presence of the first target sender characteristic; and
wherein retrieving the set of target sender characteristics comprises:
in response to absence of the first target sender characteristic in the set of target language signals, retrieving the first target sender characteristic from the external database.

9. The method of claim 1:
wherein accessing the inbound textual message comprises accessing the inbound textual message in the first format characterized by:
a first text format;
a first content order; and
a first level of abstraction; and
wherein identifying the target output format comprises identifying the target output format comprising a textual format specifying:
a target text format different from the first text format;
a target content order different from the first content order; and
a target level of abstraction different from the first level of abstraction.

10. The method of claim 1:
wherein accessing the inbound textual message comprises accessing the inbound textual message in the first format characterized by:
a first language complexity; and
a first tone; and
wherein identifying the target output format comprises identifying the target output format comprising an audio format specifying:
a target language complexity different from the first language complexity; and
a target tone different from the first tone.

11. The method of claim 1:
further comprising, in response to accessing the inbound textual message:
accessing a calendar application associated with the user and executing on the computer system;
identifying a forecast time period corresponding to user availability and represented in the calendar application; and
deriving a content limit for the output based on the forecast time period; and
wherein identifying the target output format comprises identifying the target output format based on the class of the sender, the sender specification, and the content limit.

12. The method of claim 1, wherein identifying the target output format comprises receiving selection of the target output format from the user.

13. The method of claim 1:
wherein accessing the inbound textual message comprises accessing the inbound textual message in the first format characterized by:
a first text format;
a first level of abstraction; and
a first word count;
wherein identifying the class of the sender comprises identifying the class comprising a clientele class of the sender; and
wherein identifying the target output format comprises:
accessing a second output previously generated in response to receipt of a second inbound textual message, the second inbound textual message associated with:
a second sender of a clientele class;
a second format characterized by:
a second text format;
a second level of abstraction; and
a second word count; and
a second target output format selected by the user; and
defining the target output format as the second target output format based on a correlation between the first format and the second format.

14. A method comprising:
accessing an outbound message in a first format, generated by a user via a voice recorder integrated in an application executing on a computer system;
retrieving a recipient identifier of a recipient associated with the outbound message;
identifying a class of the recipient based on the recipient identifier;
accessing a set of user preferences defining a set of target language signals and a set of target user characteristics to present to the recipient based on the class of the recipient;
retrieving the set of target user characteristics from an external database based on the set of user preferences;
accessing a recipient list assigning target output formats to outbound messages for classes of recipients;
identifying a target output format, different from the first format, for the set of target language signals and the set of target user characteristics based on the class of the recipient and the recipient list;
extracting the set of target language signals from the outbound message;
transforming the set of target language signals and the set of target user characteristics into an output in the target output format; and
serving the output to the user.

15. The method of claim 14:
wherein extracting the set of target language signals comprises extracting the set of target language signals from the outbound message at the computer system; and
wherein transforming the set of target language signals and the set of target user characteristics into the output in the target output format comprises:
generating a prompt comprising:
the set of target language signals;
the set of target user characteristics; and
the target output format;
transmitting the prompt to a remote server executing a language model; and
receiving the output from the remote server responsive to the prompt.

16. The method of claim 14:
wherein accessing the outbound message comprises accessing the outbound message comprising an audio recording generated by the user;
wherein retrieving the recipient identifier comprises retrieving an email address of the recipient;
wherein identifying the class of the recipient comprises identifying the class comprising an employee class of the recipient based on the email address;
wherein accessing the set of user preferences comprises accessing the set of user preferences defining the set of target language signals comprising a set of action item descriptions;
wherein identifying the target output format comprises identifying the target output format specifying a to-do list;
wherein extracting the set of target language signals comprises extracting:
a set of phrases; and
the set of action item descriptions; and
wherein transforming the set of target language signals and the set of target user characteristics into the output comprises:
excluding a set of nonessential phrases, in the set of phrases in the set of target language signals, from the output;
preserving a set of essential phrases, in the set of phrases in the set of target language signals, in the output;
transforming a set of transformable phrases, in the set of phrases in the set of target language signals, and the set of action item descriptions into a second set of target language signals; and
compiling the set of essential phrases and the second set of target language signals into the to-do list.

17. The method of claim 14:
wherein accessing the outbound message comprises accessing the outbound message comprising an audio recording generated by the user;
wherein retrieving the recipient identifier comprises retrieving a contact name of the recipient;
wherein identifying the class of the recipient comprises identifying the class comprising a personal contact class of the recipient;
wherein accessing the set of user preferences comprises accessing the set of user preferences defining the set of target user characteristics comprising a set of social media activity data;
wherein extracting the set of target language signals comprises extracting a set of phrases;
wherein retrieving the set of target user characteristics comprises retrieving the set of social media activity data from the external database comprising an online social networking platform;
wherein identifying the target output format comprises identifying the target output format specifying a text message; and
wherein transforming the set of target language signals and the set of target user characteristics into the output comprises:
transforming a set of transformable phrases, in the set of phrases in the set of target language signals, and the set of social media activity data into a second set of target language signals; and
compiling a set of essential phrases and the second set of target language signals into the text message.

18. The method of claim 14:
wherein accessing the outbound message comprises accessing the outbound message in the first format characterized by:
a first language complexity; and
a first tone; and
wherein identifying the target output format comprises identifying the target output format comprising a textual format specifying:
a language complexity different from the first language complexity; and
a tone different from the first tone.

19. The method of claim 14:
wherein accessing the set of user preferences comprises accessing the set of user preferences defining a first target user characteristic;
further comprising scanning the set of target language signals for presence of the first target user characteristic; and
wherein retrieving the set of target user characteristics comprises:
in response to absence of the first target user characteristic in the set of target language signals, retrieving the first target user characteristic from the external database.

20. A method comprising:
accessing an audio message in a first format, captured by a user via a voice recorder in an application executing on a computer system;
transcribing the audio message into a set of language signals;
selecting a set of input prompts from a set of predefined input prompts, each input prompt in the set of predefined input prompts defining:
a target output format; and
a definition of abstraction of target language signals; and
for each input prompt in the set of predefined input prompts:
identifying a set of target language signals in the set of language signals based on the definition of abstraction of target language signals defined in the input prompt;
inserting the set of target language signals into the input prompt to generate a transform prompt;
serving the transform prompt to a language model; and
presenting an output of the language model, responsive to the transform prompt, to the user.
